(19) United States
(12) Patent Application Publication
(10) Pub. No.: US 2025/0328582 A1
(43) Pub. Date: Oct. 23, 2025

(54) MANAGING DATA TRANSACTION LOCATION INFORMATION

(71) Applicant: Motorola Mobility LLC, Chicago, IL (US)

(72) Inventors: Krishnan Raghavan, Bangalore (IN); Nakul Patel, Bangalore (IN); Vijayprakash Idlur, Bangalore (IN)

(73) Assignee: Motorola Mobility LLC, Chicago, IL (US)

(21) Appl. No.: 18/644,006

(22) Filed: Apr. 23, 2024

(51) Int. Cl. G06F 16/587; G06F 16/583

(52) U.S. Cl. CPC G06F 16/587; G06F 16/583

(57) ABSTRACT

Techniques for managing data transaction location information are described and are implementable to generate accurate associations between data transactions and transaction locations. For instance, a computing device receives input data from a remote device that includes a request to complete a data transaction, such as with a third party. The computing device can identify a location of the remote device, such as by extracting the location from metadata included in the input data. The computing device completes the data transaction and generates an association between the data transaction and the location of the remote device. The computing device can generate a variety of transaction insights based on one or more associations.

### BACKGROUND

The use of network-based data transaction systems, such as peer-to-peer payment systems, has become commonplace across the world. For instance, users can pay for a large variety of goods and services with a network-based payment application using a portable device, e.g., a smartphone. While use of peer-to-peer payment systems and payment applications can provide a great deal of convenience, it is not without challenges. For instance, many users may be unable to access such applications and thus are reliant on a third party, such as a trusted friend or family member, to engage with the data transaction systems. However, such third-party reliance can cause convoluted and inaccurate transaction histories leading to user dissatisfaction and a variety of computational inefficiencies.

### BRIEF DESCRIPTION OF THE DRAWINGS

Aspects of managing data transaction location information are described with reference to the following Figures. The same numbers may be used throughout to reference similar features and components that are shown in the Figures:

FIG. 1 illustrates an example environment in which aspects of managing data transaction location information can be implemented.

FIG. 2 depicts an example system for managing data transaction location information in accordance with one or more implementations.

FIGS. 3a, 3b, 3c depict an example implementation for managing data transaction location information in accordance with one or more implementations.

FIGS. 4a, 4b depicts an example implementation for managing data transaction location information in which a graphical user interface is displayed that includes one or more transaction insights for a data transaction in accordance with one or more implementations.

FIGS. 5a, 5b depicts an example implementation for managing data transaction location information in which a graphical user interface is displayed that includes one or more transaction insights for a data transaction in accordance with one or more implementations.

FIGS. 6a, 6b depicts an example implementation for managing data transaction location information in which a graphical user interface is displayed that includes one or more transaction insights for a data transaction in accordance with one or more implementations.

FIG. 7 illustrates a flow chart depicting an example method for managing data transaction location information in accordance with one or more implementations.

FIG. 8 illustrates a flow chart depicting an example method for managing data transaction location information in accordance with one or more implementations.

FIG. 9 illustrates various components of an example device in which aspects of managing data transaction location information can be implemented.

### DETAILED DESCRIPTION

Techniques for managing data transaction location information are described and are implementable to associate accurate and informative location information with data transactions, e.g., payment transactions. The described implementations, for instance, support differentiation between a transaction location (e.g., a location where a transaction occurs) and a payment location, e.g., a location where the payment transaction is authorized, initiated, and/or completed.

Consider an example in which a user of a first client device wishes to partake in a data transaction, such as to purchase services and/or goods from a service provider. In this example, the user of the first client device (e.g., “Meera”) is at a small business and wishes to purchase goods from the small business. The service provider (e.g., the small business) conducts payment transactions using a peer-to-peer (“P2P”) payment system. However, many users do not have access to such P2P payment systems, such as users that are restricted because of their age, those that are technology averse, are financially reliant on others, lack devices that support such systems, etc. For instance, Meera is an adolescent and does not have a personal payment account associated with the P2P payment system and thus is personally unable to complete the transaction.

Accordingly, Meera utilizes the first client device to capture a digital image that includes a request to complete the payment transaction, e.g., a digital image of a QR code, to send to a second client device associated with her father, Ajay. The second client device receives the digital image of the QR code and completes the transaction via engagement with the QR code. Transaction data associated with the transaction (e.g., payment location, transaction amount, parties to the transaction, etc.) is generated, stored, and/or analyzed, such as to generate various transaction insights. However, because the transaction was completed by the second client device, conventional approaches incorrectly register the payment location, e.g., the location of the second client device, as a transaction location. This location misattribution leads to inaccurate transaction insights, user confusion and/or dissatisfaction upon reviewing transaction histories, and various computational inefficiencies, e.g., resource wastage caused by location misattribution.

To overcome these limitations, the techniques described herein support enhanced location attribution for data transactions, such as payment transactions. The described implementations, for example, support generation of an association between a data transaction and the transaction location, even when the data transaction is initiated at a remote location. For instance, consider the scenario described above where Meera wishes to purchase goods from the small business. The first client device, e.g., Meera's mobile device, captures a digital image that includes a request to complete a data transaction. For instance, the digital image depicts a QR code that is encoded with payment information.

The first client device detects, using one or more suitable image detection modalities, that the digital image includes the request to complete the data transaction. Responsive to detection of the request, the first client device determines and associates a current location of the first client with the digital image. Continuing with the above example, the first client device detects the QR code within the digital image and associates a location of the first client device, e.g., at the small business, with the digital image. For instance, the first client device embeds the location of the first client device within metadata of the digital image.

The first client device then communicates the digital image to an additional device to complete the data transaction. In this example, Meera's mobile device communicates the digital image to the second client device, e.g., Ajay's mobile device, which in this example is in a different location such as at their home. Upon receipt of the digital image, the second client determines that the digital image includes the request to complete the data transaction and identifies the location of the first client device. In an example to do so, the second client device extracts the location from metadata of the digital image.

The second client device further assents to the request and initiates the data transfer, such as through execution of the QR code. Responsive to completion of the data transaction, the second client device further generates an association between the location of the first client device and the data transaction. Continuing with the above example, the second client device, e.g., Ajay's mobile device, completes the payment transaction for the goods and further generates an association between the payment transaction and the location of Meera's mobile device, e.g., at the small business. The second client device then causes the association to be stored to a storage device, such as a transaction database.

The second client device is further operable to generate a variety of transaction insights based on the association. For instance, the second client device can leverage the transaction database to identify personalized transaction trends by location. In one example, the second client device displays a map in a user interface that depicts the data transaction associated with the location on the map. The map may also depict a plurality of transactions that are each associated with a transaction location. In this way, the techniques described herein overcome the limitations of conventional techniques that suffer from location misattribution and cause inaccurate transaction insights and increased computational overhead.

For instance, the techniques described herein generate accurate associations between data transactions and transaction locations. In implementations, a payment transaction represents a data transaction. For instance, digital payment transactions involve generating, transmitting, and processing various types of data across a variety of different systems and networks. Thus, such digital payment transactions can be characterized as sets of computational operations much like other operations of a computing device and/or set of computing devices.

Accordingly, by supporting enhanced accuracy and increased information associated with the data transactions, the described techniques can conserve system resources (e.g., memory, processor bandwidth, network bandwidth, etc.) that may otherwise be needlessly expended to generate transaction insights based on inaccurate information and/or used to detect and/or correct location misattributions. Thus, the described techniques can improve the operation of computing devices and data networks. Further, user burden can be reduced by performing such data transaction location association automatically while reducing user interaction to initiate and manage data transaction information storage.

While features and concepts of managing data transaction location information can be implemented in any number of environments and/or configurations, aspects of managing data transaction location information are described in the context of the following example systems, devices, and methods.

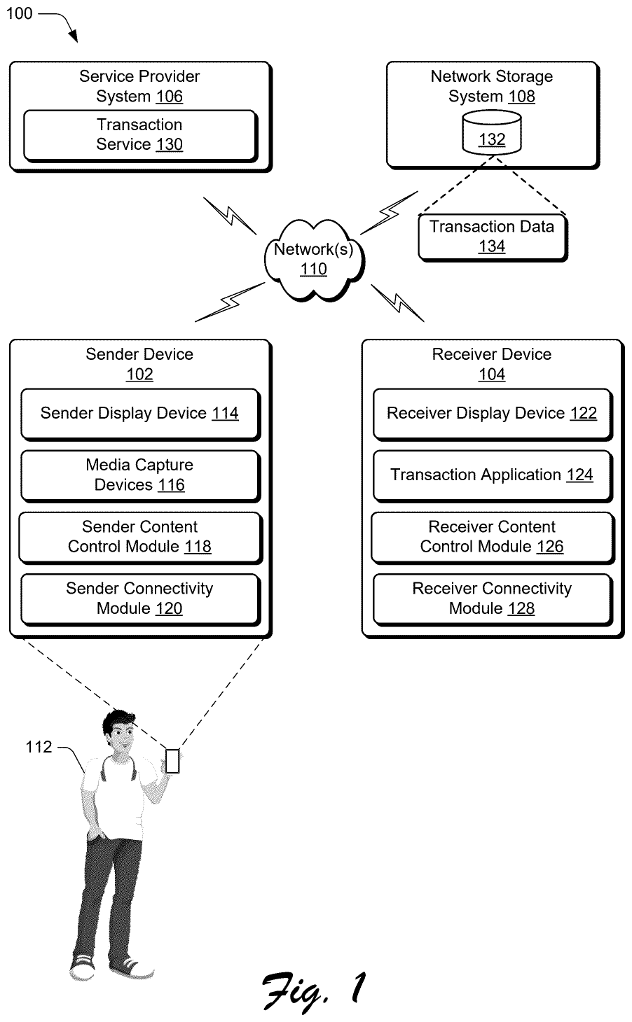

FIG. 1 illustrates an example environment 100 in which aspects of managing data transaction location information can be implemented. The environment 100 includes a sender device 102, a receiver device 104, a service provider system 106, and a network storage system 108 that are interconnectable via a network 110. The network 110 represents a wireless and/or wired network to which the sender device 102, the receiver device 104, the service provider system 106, and/or the network storage system 108 can connect, such as to enable data communication as part of implementations for managing data transaction location information as discussed herein.

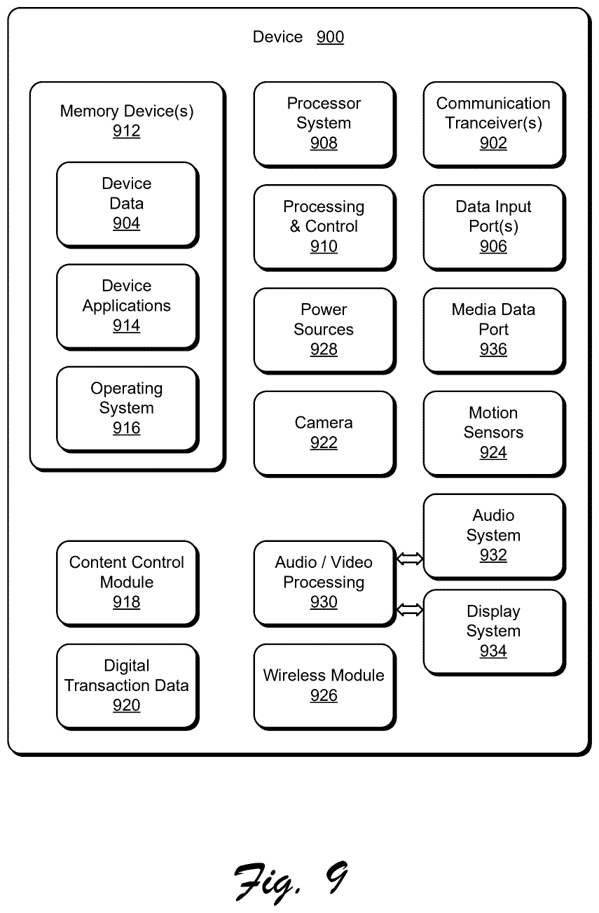

Generally, the sender device 102 represents a computing device that is operable, such as by a user 112, to communicate a request to complete a data transaction to an additional computing device, such as the receiver device 104. The receiver device 104 represents a device that can receive input data from a remote device, such as the sender device 102, that includes a request to complete a data transaction. The receiver device 104 is operable to complete the data transaction and further associate a location of the sender device 102 with the data transaction as further described below. The sender device 102 and the receiver device 104 can be implemented in various ways and include various functionality, examples of which are discussed below with reference to the example device 900 of FIG. 9.

The sender device 102 includes various functionality such as a sender display device 114, media capture devices 116, a sender content control module 118, and a sender connectivity module 120. The sender display device 114 represents functionality for graphic output by the sender device 102, such as in a user interface of the sender device 102. Further, the sender display device 114 can include touch input functionality, such as to enable the user to provide input to the sender device 102 via touch input to the sender display device 114.

The media capture devices 116 are representative of functionality to enable various types of media to be captured via the sender device 102, such as visual media and/or audio media. In various examples, the media capture devices 116 include photo/video capture devices such one or more cameras and/or audio capture devices. This is by way of example and not limitation, and the media capture devices 116 can include a variety of other devices that are able to capture various types of media in accordance with the implementations discussed herein. The media capture devices 116 further include not only hardware for capturing associated media but also logic (e.g., drivers, firmware, etc.) for operating and configuring operation of the associated media capture devices 116.

The sender content control module 118 represents functionality for performing various aspects of managing data transaction location information described herein, for instance from the perspective of the sender device 102. Generally, the sender content control module 118 is operable to cause the sender device 102 to detect and/or generate a request to complete a data transaction, to associate a location of the sender device 102 with the request, and communicate the request to an additional device, such as the receiver device 104.

The sender connectivity module 120 enables wireless and/or wired connectivity of the sender device 102. In an example, the sender device 102 leverages the sender connectivity module 120 to communicate the request. The sender connectivity module 120 represents functionality (e.g., logic and hardware) for enabling the sender device 102 to interconnect with other devices, storage systems, and/or networks, such as the network 110 and the receiver device 104.

The receiver device 104 includes various functionality such as a receiver display device 122, a transaction application 124, a receiver content control module 126, and a receiver connectivity module 128. The receiver display device 122 represents functionality for graphic output by the receiver device 104, such as in a user interface of the receiver device 104. Further, the receiver display device 122 can include touch input functionality, such as to enable the user to provide input to the receiver device 104 via touch input to the receiver display device 122.

The transaction application 124 represents functionality for participating in different stages of payment transactions, such as receiving, initiating, authenticating, approving, and/or completing payment transactions. In one or more examples, the transaction application 124 includes a payment GUI that can be output via the receiver display device 122 to enable a user to view payment transaction status (e.g., incoming/outgoing payment transactions) and to perform different actions pertaining to payment transactions. In various implementations, the transaction application 124 is connected to the network 110 and can participate in various processes pertaining to data transactions.

For instance, the transaction application 124 enables the receiver device 104 to connect with a transaction service 130 of the service provider system 106. The service provider system 106, for instance, includes a framework and/or infrastructure to provide digital/physical services and/or goods. In one example, the service provider system 106 is associated with a physical location, e.g., a brick-and-mortar storefront. The service provider system 106 can include a variety of processes, technologies, and/or resources to provide the services and/or goods. In an example, the service provider system 106 provides the transaction service 130 that represents functionality to perform a variety of data transactions in relation to the provision of services and/or goods. In one example, the transaction service 130 is representative of a peer-to-peer payment service. While depicted here as implemented by the service provider system 106, in various examples the transaction service 130 can be implemented in whole or in part by the sender device 102 and/or the receiver device 104.

The receiver content control module 126 represents functionality for performing various aspects of managing data transaction location information described herein, for instance from the perspective of the receiver device 104. Generally, the receiver content control module 126 is operable to receive input data from the sender device 102 that includes a request to complete a data transaction, identify a location of the sender device 102, complete the data transaction, and generate an association between the data transaction and the location of the sender device 102. The receiver content control module 126 is further operable to cause the association to be stored, such as to storage 132.

Generally, the storage 132 is operable to store transaction data 134. The transaction data 134, for instance, can include information about one or more data transactions such as a transaction time, a location where the transaction was requested (e.g., a transaction location such as a location of the sender device 102), a location where the transaction was initiated/completed (e.g., a payment location such as a location of the receiver device 104), an amount of computational resources used to complete the transaction (e.g., processing power, memory, storage, network bandwidth, etc. of the sender device 102 and/or the receiver device 104), etc. In this example, the storage 132 is maintained by the network storage system 108. In addition to maintaining the storage 132, the network storage system 108 is further operable to generate a variety of data transaction insights and/or personalized data transaction reports as described in more detail below. While in this example the network storage system 108 is depicted as a separate entity, in various examples the network storage system 108 is maintained in whole or in part by one or more of the sender device 102, receiver device 104, and/or the service provider system 106.

The receiver connectivity module 128 enables wireless and/or wired connectivity of the receiver device 104. In an example, the receiver device 104 leverages the receiver connectivity module 128 to communicate with one or more of the sender device 102, the service provider system 106, and/or the network storage system 108. The receiver connectivity module 128 represents functionality (e.g., logic and hardware) for enabling the receiver device 104 to interconnect with other devices, storage systems, and/or networks, such as the network 110 and the sender device 102. Having discussed an example environment in which the disclosed techniques can be performed, consider now some example scenarios and implementation details for implementing the disclosed techniques.

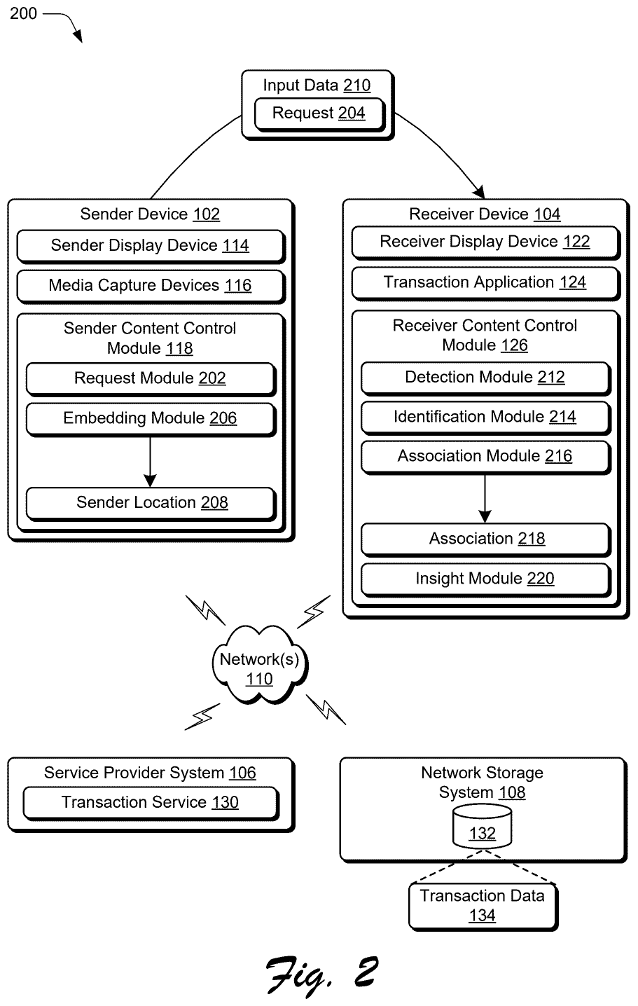

FIG. 2 depicts an example system 200 for managing data transaction location information in accordance with one or more implementations. The system 200 can be implemented in the environment 100 and incorporates attributes of the environment 100 introduced above. In the example system 200, the sender device 102 engages with the service provider system 106. For instance, this includes interaction between the sender device 102 and the service provider system 106 in a digital context, e.g., via a website, application, email, social media channel etc. associated with the service provider system 106. Additionally or alternatively, a user 112 of the sender device 102 interacts with a brick-and-mortar embodiment associated with the service provider system 106, such as to interact with one or more goods and/or services provided by the service provider system 106.

By way of example, the user 112 of the sender device 102 interacts with a physical location associated with the service provider system 106. For instance, the user 112 desires to purchase a good from a storefront associated with the service provider system 106. The service provider system 106 utilizes a transaction service 130 to purchase the good such as a payment system, e.g., Dimo, UPI, Pay™, Pix, Venmo, PayPal, Zelle, Cash App, etc. However, the sender device 102 does not support engagement with the transaction service 130 for a variety of reasons. For instance, the sender device does not have the requisite hardware and/or software to support engagement with the transaction service 130. Accordingly, the sender device 102 includes a request module 202 that is operable to generate a request 204 to complete a data transaction.

In an example, the request module 202 leverages one or more media capture devices 116, such as an image capture device, to capture an image that includes the request 204. Continuing with the above example, the physical location associated with the service provider system 106 includes a display of a link to perform a data transaction via the transaction service 130, such as a QR code and/or barcode to complete a payment transaction. This is by way of example and not limitation, and a variety of transaction links to engage in a data transaction are considered. The request module 202 leverages an image capture device to capture a digital image of the display that includes the request 204, e.g., the QR code. In one or more implementations, the transaction application 124 leverages the media capture devices 116 to capture the digital image that includes the request 204.

In an additional or alternative example, the request module 202 is operable to configure the request 204 for delivery by one or more communication applications, e.g., within a messaging application. For instance, the sender device 102 generates a request 204 via a text message to complete a data transaction. In an example, the user 112 of the sender device 102 sends a text message to the receiver device 104 that indicates the request 204 to complete the data transaction.

The sender content control module 118 further includes an embedding module 206 that can associate a current location of the sender device 102, e.g., a sender location 208, with the request 204 responsive to detection of the request 204. For instance, the embedding module 206 is operable to detect the presence of the request 204. For instance, the embedding module 206 can detect that a digital image captured by the sender device 102 includes a link to initiate a data transaction, such as a QR code, using one or more image recognition techniques. The embedding module 206 can also decode the QR code to detect that the digital image includes the request 204.

In an additional or alternative example, the embedding module 206 leverages one or more text-recognition technologies (e.g., OCR, NLP machine learning models, etc.) to identify that a text message from the sender device 102 includes the request 204. For instance, the embedding module 206 can detect key phrases such as “please pay,” or “send payment to” that correspond to a request to complete a data transaction.

Responsive to detection of the request 204, the embedding module 206 can determine the sender location 208 automatically and without user intervention. The embedding module 206 can leverage a variety of modalities to do so, such as GPS, A-GPS, Wi-Fi positioning systems, using BLE beacons, location-based services, cellular triangulation, etc. For instance, the embedding module 206 leverages one or more sensors of the sender device 102, e.g., one or more geographical location information sensors such as GPS sensors, to identify the sender location 208. The embedding module 206 can further validate the sender location 208 against an address associated with a party to the data transaction such as the service provider system 106. For instance, the embedding module 206 compares the sender location 208 with an address associated with the service provider system 106.

The embedding module 206 then associates the sender location 208 with the request 204. In one example, the embedding module 206 embeds the sender location 208 within metadata of a digital image that includes the request 204. In an additional or alternative example, the embedding module 206 embeds the sender location 208 within metadata of a text message that includes the request 204. This is by way of example and not limitation, and the embedding module 206 can associate the sender location 208 with the request 204 in a variety of suitable ways. Once generated, the sender device 102 communicates the request 204 to an additional computing device to complete the data transaction.

For instance, the receiver device 104 receives input data 210 from the sender device 102 that includes the request 204. In various examples, the input data 210 includes a digital communication, such as a text message, email, social media communication, voice call, video chat, etc. In one example, the input data 210 includes a digital image and/or digital video that depicts a link, e.g., a QR code, to initiate a data transaction. In this example, the receiver device 104 is located at a location remote from the sender location 208.

Upon receipt of the input data 210, the receiver content control module 126 of the receiver device 104 leverages a detection module 212 to detect the request 204 within the input data 210. For example, the input data 210 includes a digital image of a transaction link such as a QR code and detection of the request 204 includes decoding the QR code. In another example, the input data 210 includes a text message and the detection module 212 can detect the request 204 by identifying one or more key words and/or phrases that indicate the presence of the request 204. For instance, the input data 210 includes text such as “please pay,” “send payment to,” “transfer data to,” etc. In at least one example, the detection module 212 leverages a text-analysis machine learning model to detect the one or more key words and/or phrases.

The receiver device 104 further includes an identification module 214 that can identify a location of the sender device 102, e.g., the sender location 208, responsive to detection of the request. In one example, the identification module 214 extracts the sender location 208 from metadata associated with the input data 210. For instance, the input data 210 includes a digital image and the identification module 214 extracts the sender location 208 from metadata of the digital image. The identification module 214 can also validate the sender location 208, such as by comparing the sender location 208 to an address associated with a party to the data transaction, such as the service provider system 106.

The receiver device 104 includes a transaction application 124 that is operable to complete the data transaction included in the request 204. For instance, the receiver device 104 leverages the transaction application 124 to complete a data transaction with the service provider system 106 via the transaction service 130. A variety of data transactions are considered that include but are not limited to payment transactions, blockchain transactions, file transfer transactions, etc. In one example, upon completion of the data transaction, the receiver device 104 generates an indication that the that the data transaction has been completed for communication to the sender device 102. The sender device 102 receives the indication and generates a transaction receipt for display by the sender display device 114 that includes an association 218 between the sender location 208 and the data transaction.

For instance, the receiver device 104 includes an association module 216 that is operable to generate the association 218 between the sender location 208 and the data transaction. Once generated, the receiver device 104 causes the association 218 to be stored to a storage device, such as to storage 132 as part of the transaction data 134. In at least one example, the association 218 is stored locally, e.g., on the receiver device 104. In an alternative or additional example, the association 218 is stored remotely and/or by a third party such as by a network storage system 108. In various implementations, the association 218 further includes an additional location of the receiver device 104 during completion of the data transaction.

The receiver device 104 further includes an insight module 220 that is operable to generate one or more data transaction insights based on the association 218, such as for display by the receiver display device 122. While depicted as implemented by the receiver device 104, in various examples the insight module 220 is implemented in whole or in part by an external device and/or system, such as one or more data transaction services, e.g., a banking service. Generally, the data transaction insights include one or more instances of information, patterns, trends, and/or correlations based on one or more associations 218. In an example, the data transaction insights provide a visual representation to display data transaction information and behaviors that are based in part on the association 218. In some examples the data transaction insights are based on a relationship between one or more of the association 218, the sender location 208, and/or a location of the receiver device 104 during execution of the data transaction.

The data transaction insights can include a variety of information and/or representations such as a data transaction history, a data transaction resource usage summary, categorization of transaction habits, data transaction recommendations (e.g., to reduce cost and/or computational expense), etc. In an example, the data transaction insights include a map that depicts the sender location 208 associated with the data transaction as well as additional information about the transaction, such as transaction data 134. In at least one example, the data transaction insights include a data transaction location heatmap based on a plurality of transaction locations. This is by way of example and not limitation, and a variety of transaction insights, e.g., transaction insights related to a sender location 208, are considered. In this way, the techniques described herein overcome the limitations of conventional techniques that suffer from location misattribution and increased computational overhead as a result of inaccurate transaction insights.

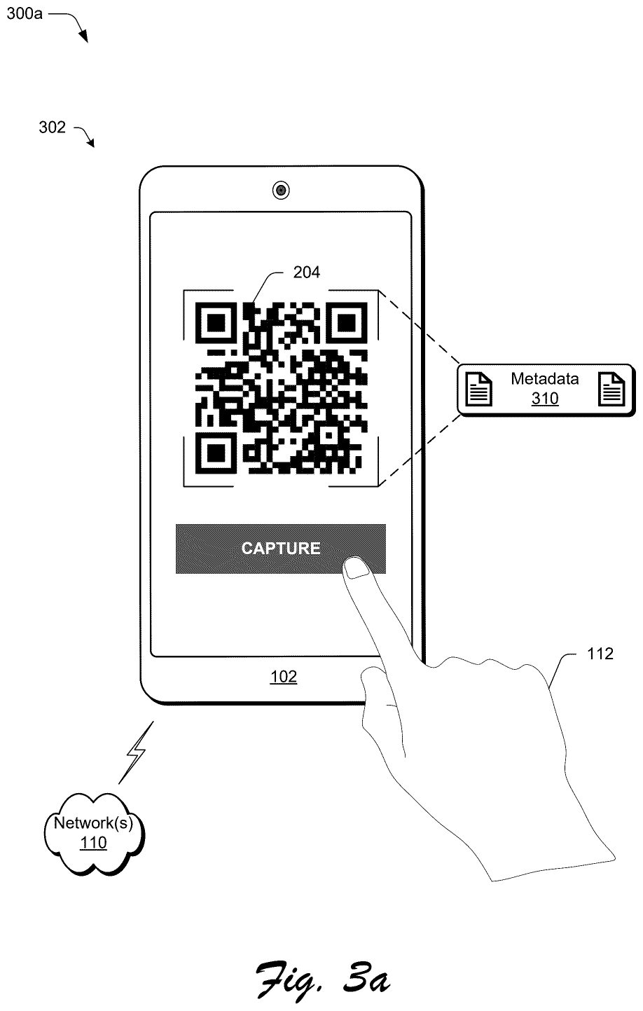

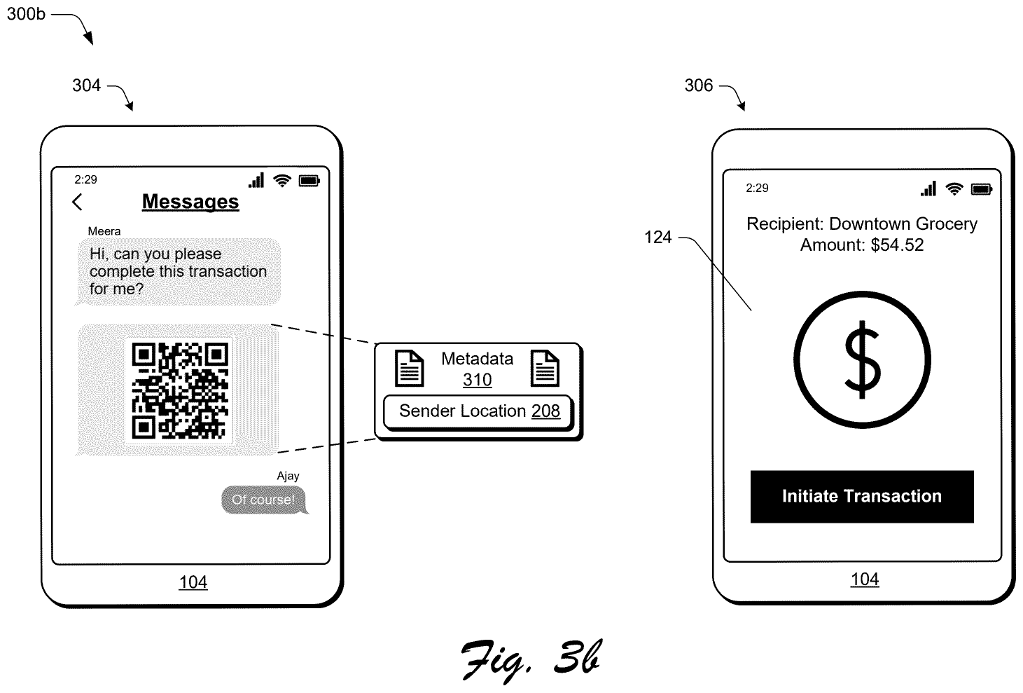

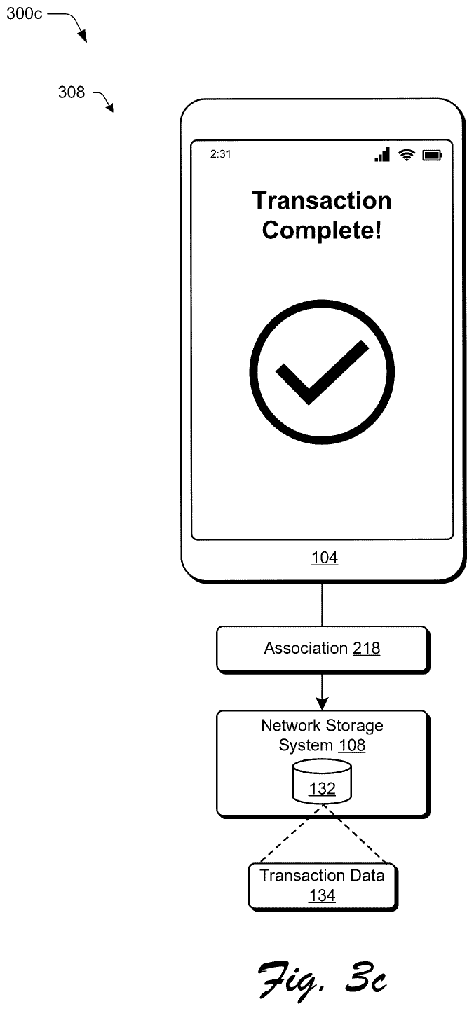

FIGS. 3a, 3b, and 3c depict an example implementation 300a, 300b, and 300c for managing data transaction location information in accordance with one or more implementations. In this example, shown in first stage 302, second stage 304, third stage 306, and a fourth stage 308, a user 112 of the sender device 102 desires to purchase a service from a service provider, such as groceries from a small grocer. The service provider conducts data transactions using a transaction service 130, such as a payment service, however the sender device 102 does not support engagement with the transaction service 130. For instance, the sender device 102 may not be able to user the transaction service 130 because of one or more network restrictions, compatibility issues, geographical restrictions, limited computational resources (e.g., processing power, memory, bandwidth, battery availability, etc.), software and/or hardware limitations, lack of access to a transaction service 130, etc.

Accordingly, as shown in first stage 302 the sender device 102 captures a digital image that includes a request 204 to complete a data transaction. For instance, the service provider provides a transaction link such as a QR code to initiate data transactions such as payments via a payment service and the sender device 102 captures a digital image of the QR code. In accordance with the techniques described herein, the sender device 102 detects that the digital image includes the request 204 and associates a location of the sender device 102, e.g., the sender location 208, with the digital image. In this example, the sender device 102 embeds the sender location 208 within metadata 310 of the digital image. A variety of formats for the metadata 310 can be used, such as exchangeable image file format (“EXIF”), extensible metadata platform (“XMP”), custom metadata formats, etc. The sender device 102 can then communicate the digital image associated with the sender location 208 to an additional computing device, such as the receiver device 104 via the network 110.

As depicted in the second stage 304, for instance, the receiver device 104 receives input data 210 from a remote device, e.g., the sender device 102, which is displayed in a user interface by the receiver display device 122. In the illustrated example, the input data 210 includes a text message with the digital image of the QR code, which represents the request 204 to complete the data transaction. The receiver device 104 decodes the QR code to detect the request 204. Responsive to detection of the request 204, the receiver device 104 identifies the sender location 208. For instance, the receiver device 104 extracts the sender location 208 from the metadata 310 of the digital image. As shown in third stage 306, the receiver display device 122 displays a user interface of a transaction application 124, e.g., a payment GUI, to initiate the transaction with the service provider. For instance, the transaction application 124 enables the receiver device 104 to initiate a payment transfer for the groceries. The user interface also displays information related to the request 204, such as a recipient and a transaction amount. Although not depicted in the illustrated example, the user interface may also display the sender location 208.

As shown in the fourth stage 308, the receiver device 104 completes the data transaction with the service provider system 106. Responsive to completion of the data transaction, the receiver device 104 generates an association 218 between the data transaction and the sender location 208. Further, in this example the receiver device 104 causes the association 218 to be stored as part of transaction data 134 in storage 132 of a network storage system 108. The receiver device 104 is then able to generate, receive, and/or display one or more transaction insights based on the stored association 218 as well as one or more additional associations.

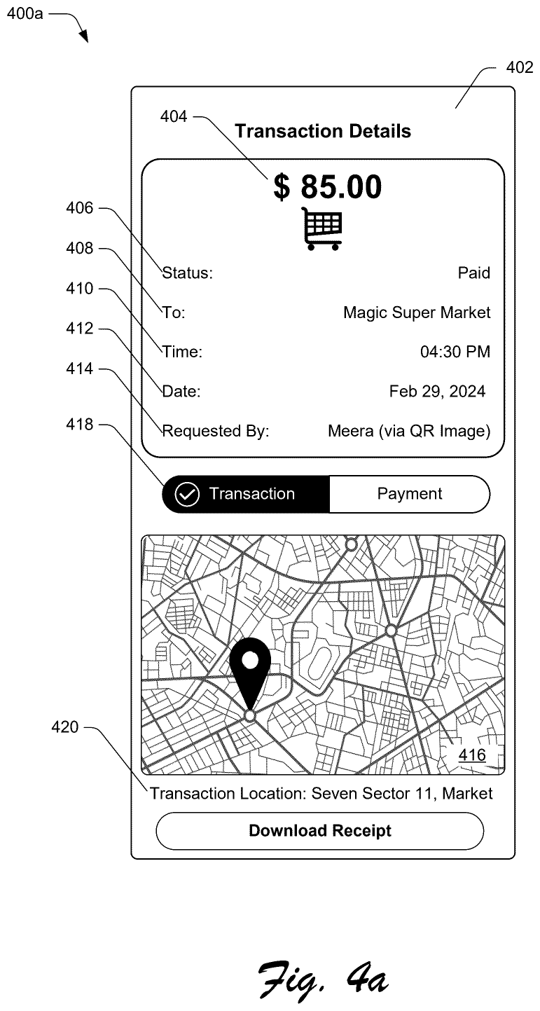

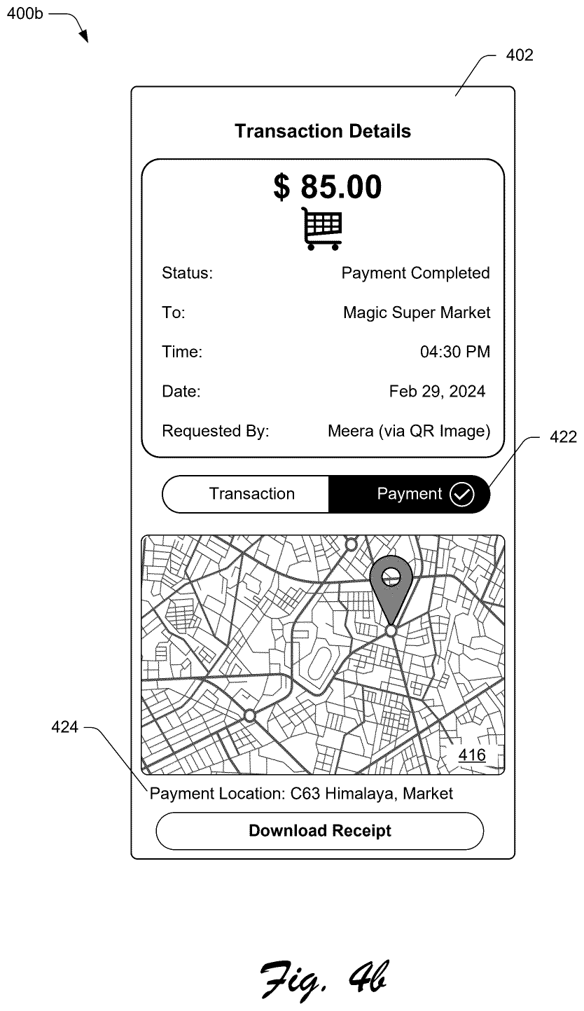

FIGS. 4a, 4b, depict example implementations 400a, 400b, for managing data transaction location information in which a graphical user interface is displayed that includes one or more transaction insights for a data transaction in accordance with one or more implementations. As shown in FIG. 4a, for instance, a graphical user interface 402 may be generated, presented, and/or managed by the sender device 102 and/or the receiver device 104 that depicts transaction insights for a data transaction such as a payment transaction. The graphical user interface 402 includes a transaction amount region 404, a transaction status region 406, a recipient identifier 408, a transaction time 410, a transaction date 412, and a request identifier 414.

The transaction amount region 404 indicates a payment amount of the payment transaction and the transaction status region 406 indicates that the data transaction has been completed, e.g., paid. The recipient identifier 408 indicates a recipient of the data transaction, e.g., a service provider system 106 that the receiver device 104 engages with to perform the data transaction. The transaction time 410 and the transaction date 412 indicate when the data transaction occurred. The request identifier 414 indicates “who” requested the data transaction. For instance, the request identifier 414 corresponds to a user 112 of a sender device 102 that generated the request 204 to complete the data transaction. The request identifier 414 further indicates the form of the request, e.g., by QR code.

In this example, the graphical user interface 402 further includes a transaction map 416 that depicts a representation of a map. The graphical user interface 402 includes a selectable toggle switch that supports selection of what is displayed by the transaction map 416. In the example implementation 400a, for instance, a transaction toggle button 418 of the toggle switch is selected. Accordingly, the graphical user interface 402 includes a transaction location 420, which in this example corresponds to the sender location 208 at the time of the data transaction. Further, the transaction map 416 displays the transaction location 420, denoted by a black pin on the transaction map 416.

As shown in FIG. 4b, a payment toggle button 422 is selected. Accordingly, the graphical user interface 402 includes a payment location 424, which in this example corresponds to a location of the receiver device 104, e.g., the “payer” device, at the time of the data transaction. Further, the transaction map 416 displays the payment location 424, denoted by a grey pin on the transaction map 416. In this way, the techniques described herein can differentiate between a transaction location and a payment location, and further provide a clear representation of the differentiation in a user interface.

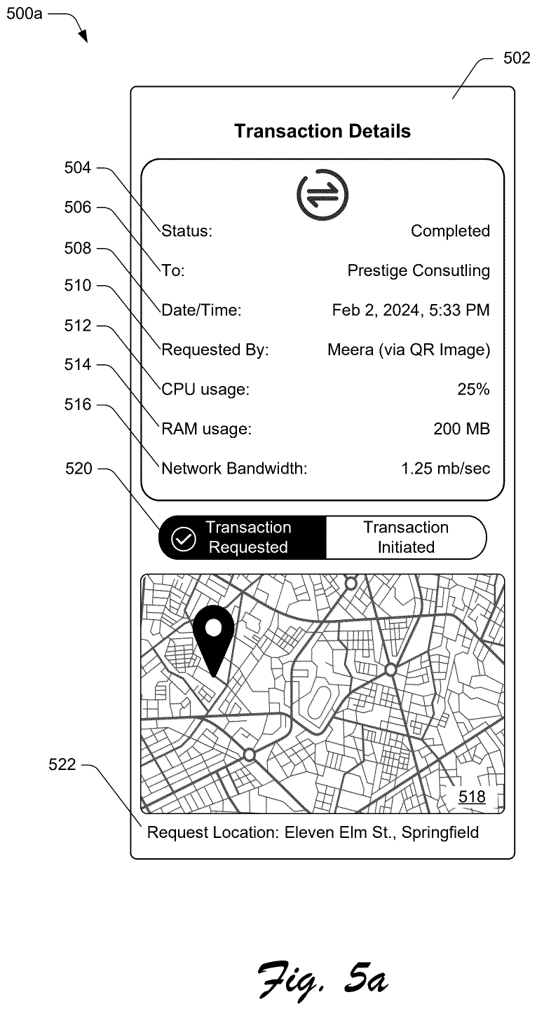

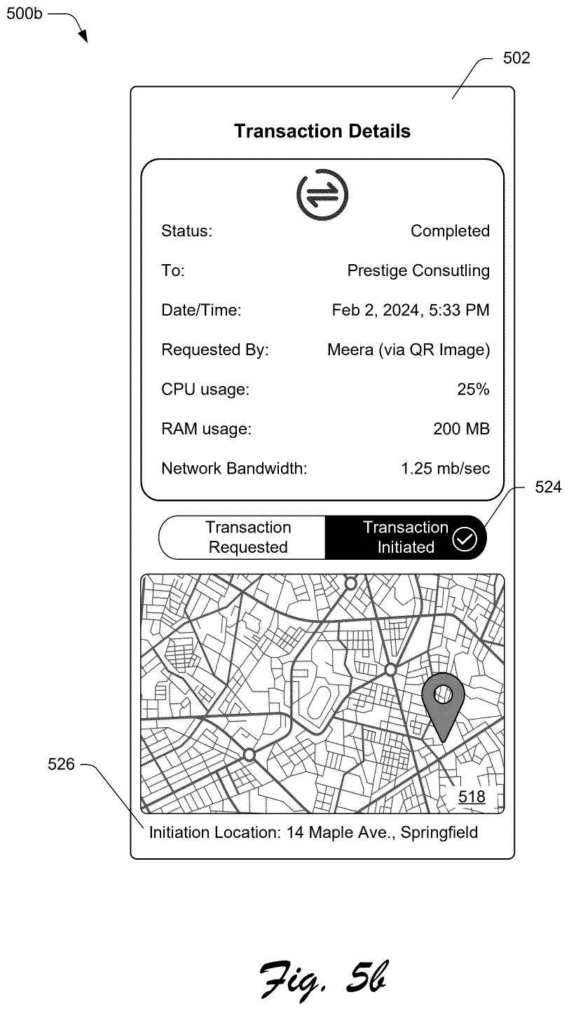

FIGS. 5a, 5b, depict example implementations 500a, 500b for managing data transaction location information in which a graphical user interface is displayed that includes one or more transaction insights for a data transaction in accordance with one or more implementations. As shown in FIG. 5a, for instance, a graphical user interface 502 may be generated, presented, and/or managed by the sender device 102 and/or the receiver device 104 that depicts transaction insights for a data transaction such as a payment transaction. In this example, the data transaction includes a file transfer between the receiver device 104 and a third party, such as a service provider system 106. For instance, the sender device 102 does not have sufficient computational resources to complete the data transaction. Thus, the sender device 102 generates a request 204 for the receiver device 104 to complete the data transaction in accordance with the techniques described herein.

The graphical user interface 502 includes a transaction status region 504, a recipient identifier 506, a transaction time 508, and a request identifier 510. The transaction status region 504 indicates that the data transaction has been completed. The recipient identifier 506 indicates a recipient of the data transaction, e.g., a service provider system 106 that the receiver device 104 engages with to perform the data transaction. The transaction time 410 indicates when the data transaction occurred. The request identifier 414 indicates “who” requested the data transaction. For instance, the request identifier 414 corresponds to a user 112 of a sender device 102 that generated the request 204 to complete the data transaction. The request identifier 414 further indicates the form of the request, e.g., by QR code.

The graphical user interface 502 further includes a CPU usage identifier 512, a RAM usage identifier 514, and a Network Bandwidth identifier 516. The CPU usage identifier 512, RAM usage identifier 514, and Network Bandwidth identifier 516 each provide information about the data transaction itself and are further usable to provide a variety of additional insights. For instance, such metrics are usable to optimize data transactions and/or to conserve computational resources.

Similar to the example discussed with respect to FIG. 4a, 4b, the graphical user interface 502 includes a selectable toggle switch that supports selection of what is displayed by a transaction map 518. In the example implementation 500a, for instance, a request button 520 of the toggle switch is selected. Accordingly, the graphical user interface 502 includes a transaction request location 522, which in this example corresponds to the sender location 208 at the time of the data transaction, e.g., where the data transaction request 204 was generated. Further, the transaction map 518 displays the transaction request location 522, denoted by a black pin on the transaction map 518.

As shown in FIG. 5b, an initiation toggle button 524 is selected. Accordingly, the graphical user interface 502 includes a transaction initiation location 526, which in this example corresponds to a location of the receiver device 104 at the time of the data transaction. Further, the transaction map 518 displays the transaction initiation location 526, denoted by a grey pin on the transaction map 518. Thus, the techniques described herein are able to generate transaction insights for a variety of data transactions.

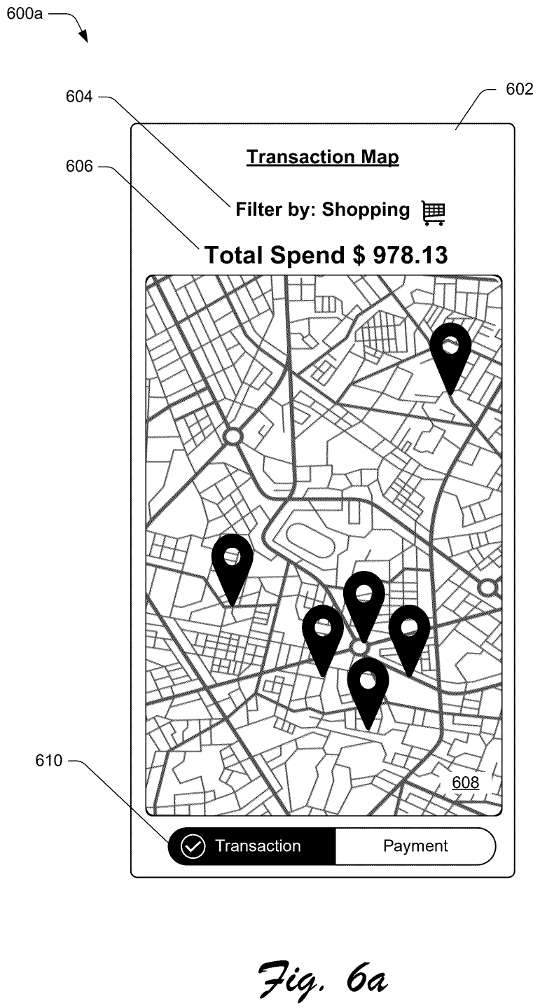

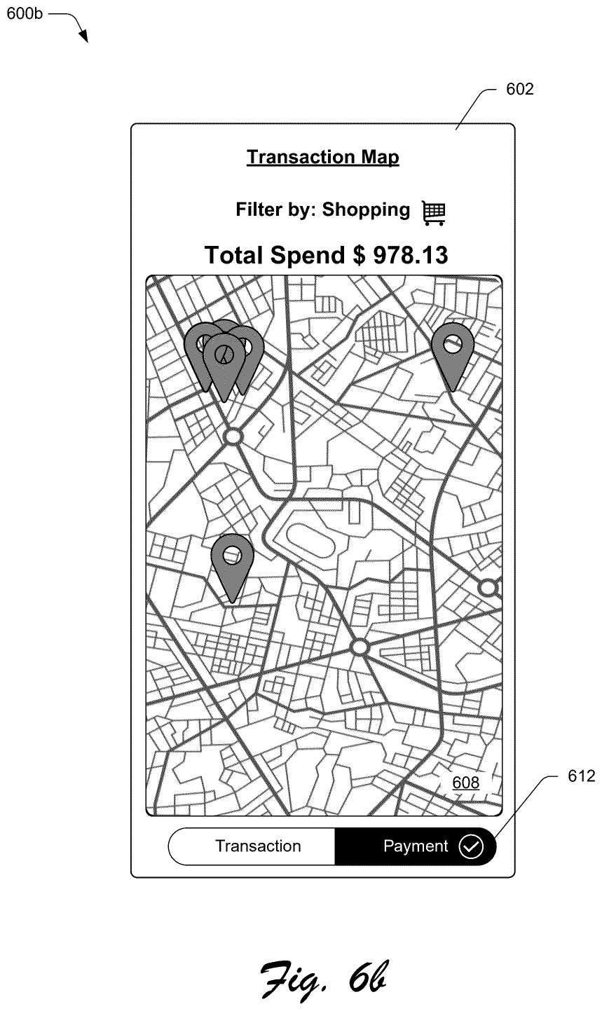

FIGS. 6a, 6b, depict example implementations 600a, 600b, for managing data transaction location information in which a graphical user interface is displayed that includes one or more transaction insights for a data transaction is in accordance with one or more implementations. As shown in FIG. 6a, for instance, a graphical user interface 602 may be generated, presented, and/or managed by the sender device 102 and/or the receiver device 104 that depicts transaction insights for multiple data transactions. For example, the receiver device 104 accesses the storage 132 to obtain a plurality of associations 218. Based on the plurality of associations 218, the receiver device 104 can generate a variety of transaction insights for display.

For instance, the graphical user interface 602 includes a filter indicator 604, a total spend region 606, and a transaction map 608. The filter indicator 604 indicates a category of data transactions, e.g., “shopping” payment transactions. The total spend region 606 indicates a cumulative amount within the category of data transactions, e.g., an amount spent on all shopping payment transactions within a period of time. The graphical user interface 602 further includes a selectable toggle switch that supports selection of what is displayed by the transaction map 608. In the example implementation 600a, for instance, a transaction button 610 of the toggle switch is selected. Accordingly, the transaction map 608 displays a variety of pins that correspond to transaction locations of a variety of data transactions, e.g., locations where respected data transactions were requested. As shown in FIG. 6b, a payment button 612 of the toggle switch is selected. Accordingly, the transaction map 608 displays a variety of pins that correspond to payment locations of the variety of data transactions, e.g., locations where the data transactions were completed.

Although not depicted in the illustrated example, in some examples the graphical user interface 602 generates one or more visual indicia based on a correlation between one or more transaction locations and one or more payment locations. In one example, the graphical user interface 602 includes an option to overlay transaction locations on payment locations on the transaction map 608, such as to provide a visual comparison between the two locations. In another example, the graphical user interface 602 is operable to identify transactions that share and/or do not share a payment location and a transaction location. Thus, the techniques described herein support a variety of insights that are not possible using conventional approaches.

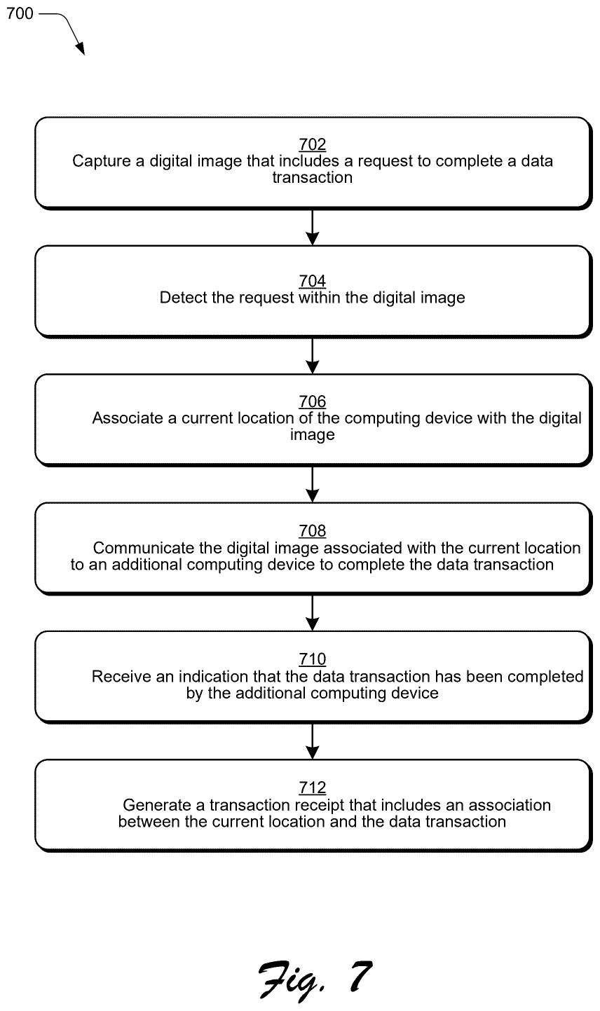

FIG. 7 illustrates a flow chart depicting an example method 700 for managing data transaction location information in accordance with one or more implementations. At 702, a digital image is captured that includes a request to complete a data transaction. For instance, the sender device 102 leverages the media capture devices 116 to capture a digital image that includes a link to complete the data transaction. The data transaction, for instance, includes one or more of a payment transaction, communication transaction, content transaction, data storage and retrieval transaction, system and/or software transactions, etc.

At 704, the request is detected within the digital image. For instance, the sender device 102 leverages one or more image recognition techniques to detect the request 204. In an example in which the request 204 includes a link to access the data transaction (e.g., a QR code) the sender device 102 may detect the request 204 through execution of the link. At 706, a current location of the computing device is associated with the digital image. For instance, the sender device 102 embeds the location within metadata of the digital image responsive to detection of the request 204.

At 708, the digital image associated with the current location is communicated to an additional computing device to complete the data transaction. For instance, the sender device 102 is unable to complete the data transaction directly and communicates the request 204 to the receiver device 104 to complete the data transaction. The sender device 102 can communicate the digital image and the request 204 to the receiver device 104 in a variety of ways, such as text message, video communication, file sharing, social media messaging, etc.

At 710, an indication is received that the data transaction has been completed by the additional computing device. For instance, the indication indicates that the receiver device 104 has completed the data transaction. At 712, a transaction receipt is generated that includes the association between the current location and the data transaction. For instance, the sender device 102 displays the transaction receipt such as via the sender display device 114 such as to confirm completion of the data transaction.

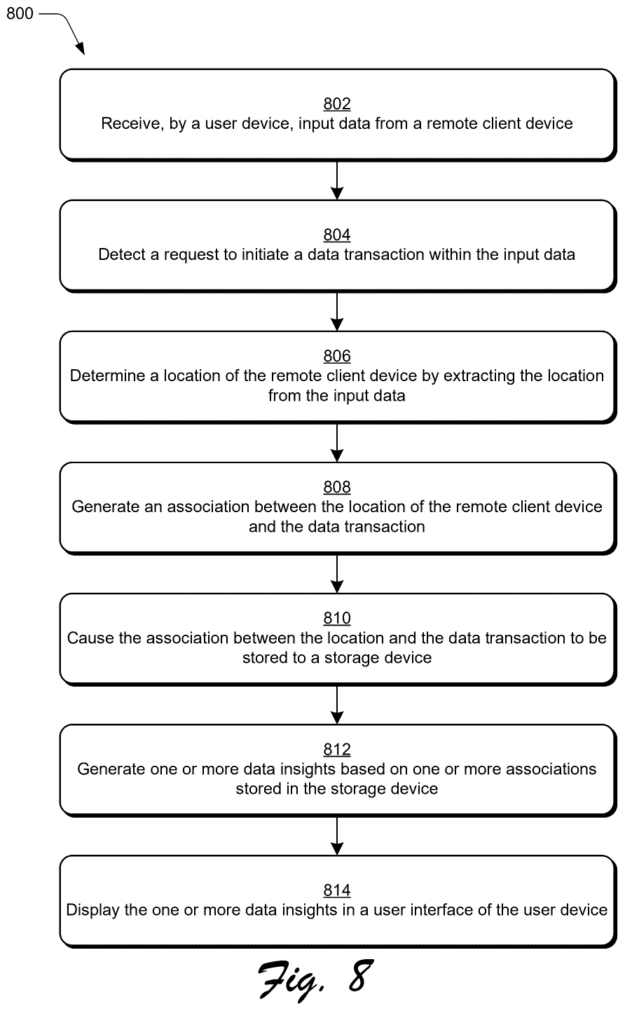

FIG. 8 illustrates a flow chart depicting an example method 800 for managing data transaction location information in accordance with one or more implementations. At 802 input data is received by a user device from a remote client device. For instance, the receiver device 104 receives input data from the sender device 102. In one example, the input data 210 includes a digital communication such as a text message, phone call, video chat, etc. Additionally or alternatively, the input data 210 includes a digital image.

At 804, a request is detected to initiate a data transaction within the input data. For instance, the input data 210 includes a digital image and the receiver device 104 detects the presence of a link to initiate the data transfer. In one example, the digital image includes a QR code and the receiver device 104 detects the request by decoding the QR code. In another example, the input data 210 includes a text message and the receiver device 104 detects the request 204 using one or more text analysis modalities.

At 806, a location of the remote client device is determined by extracting the location from the input data. In one example, the receiver device 104 extracts the location, e.g., the sender location 208, from metadata associated with the input data 210. For instance, the input data 210 includes a digital image and the identification module 214 extracts the sender location 208 from EXIF metadata of the digital image. The identification module 214 can also validate the sender location 208, such as by comparing the sender location 208 to an address associated with a party to the data transaction, such as the service provider system 106.

At 808, an association is generated between the location of the remote client device and the data transaction. For instance, the receiver device 104 generates transaction data 134 that includes the association 218. At 810, the association between the location and the data transaction is stored to a storage device. In at least one example, the receiver device 104 stores the association 218 locally, e.g., on the receiver device 104. Additionally or alternatively, the receiver device 104 causes the association 218 to be stored remotely, e.g., by a network storage system 108.

At 812, one or more data insights are generated based on one or more associations stored in the storage device. The receiver device 104, for instance, accesses storage 132 to obtain one or more associations 218 between various locations and data transactions. Generally, the data transaction insights include one or more instances of information, patterns, trends, and/or correlations based on the one or more associations 218. In some examples the data transaction insights are based on a relationship between one or more of the association 218, the sender location 208, and/or a location of the receiver device 104 during execution of the data transaction.

At 814, the one or more data insights are displayed in a user interface of the user device. In an example, the data insights are usable to generate a view of a map that includes the one or more associations 218 between the locations and the data transactions. In at least one example, the data insights include a data transaction location heatmap based on a plurality of transaction locations that is displayed by the receiver display device 122. In this way, the techniques described herein overcome the limitations of conventional techniques that suffer from location misattribution and increased computational overhead as a result of inaccurate transaction insights.

FIG. 9 illustrates various components of an example device 900 in which aspects of managing data transaction location information can be implemented. The example device 900 can be implemented as any of the devices described with reference to the previous FIGS. 1-8, such as any type of mobile device, mobile phone, mobile device, wearable device, tablet, computing, communication, entertainment, gaming, media playback, and/or other type of electronic device. For example, the sender device 102 and/or the receiver device 104 as shown and described with reference to FIGS. 1-8 may be implemented as the example device 900.

The device 900 includes communication transceivers 902 that enable wired and/or wireless communication of device data 904 with other devices. The device data 904 can include any of device identifying data, device location data, wireless connectivity data, and wireless protocol data. Additionally, the device data 904 can include any type of audio, video, and/or image data. Example communication transceivers 902 include wireless personal area network (WPAN) radios compliant with various IEEE 902.15 (Bluetooth™) standards, wireless local area network (WLAN) radios compliant with any of the various IEEE 902.11 (Wi-Fi™) standards, wireless wide area network (WWAN) radios for cellular phone communication, wireless metropolitan area network (WMAN) radios compliant with various IEEE 902.16 (WiMAX™) standards, and wired local area network (LAN) Ethernet transceivers for network data communication.

The device 900 may also include one or more data input ports 906 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 900 includes a processing system 908 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 910. The device 900 may further include any type of a system bus or other data and command transfer system that couples the various components within the device. A system bus can include any one or combination of different bus structures and architectures, as well as control and data lines.

The device 900 also includes computer-readable storage memory 912 (e.g., memory devices) that enable data storage, such as data storage devices that can be accessed by a computing device, and that provide persistent storage of data and executable instructions (e.g., software applications, programs, functions, and the like). Examples of the computer-readable storage memory 912 include volatile memory and non-volatile memory, fixed and removable media devices, and any suitable memory device or electronic data storage that maintains data for computing device access. The computer-readable storage memory can include various implementations of random-access memory (RAM), read-only memory (ROM), flash memory, and other types of storage media in various memory device configurations. The device 900 may also include a mass storage media device.

The computer-readable storage memory 912 provides data storage mechanisms to store the device data 904, other types of information and/or data, and various device applications 914 (e.g., software applications). For example, an operating system 916 can be maintained as software instructions with a memory device and executed by the processing system 908. The device applications may also include a device manager, such as any form of a control application, software application, signal-processing and control module, code that is native to a particular device, a hardware abstraction layer for a particular device, and so on. Computer-readable storage memory 912 represents media and/or devices that enable persistent and/or non-transitory storage of information in contrast to mere signal transmission, carrier waves, or signals per se. Computer-readable storage memory 912 do not include signals per se or transitory signals.

In this example, the device 900 includes a content control module 918 that implements aspects of managing data transaction location information and may be implemented with hardware components and/or in software as one of the device applications 914. In an example, the content control module 918 can be implemented as the sender content control module 118 and/or the receiver content control module 126 described in detail above. In implementations, the content control module 918 may include independent processing, memory, and logic components as a computing and/or electronic device integrated with the device 900. The device 900 also includes digital transaction data 920 for implementing aspects of managing data transaction location information and may include data from and/or utilized by the content control module 918.

In this example, the example device 900 also includes a camera 922 and motion sensors 924, such as may be implemented in an inertial measurement unit (IMU). The motion sensors 924 can be implemented with various sensors, such as a gyroscope, an accelerometer, and/or other types of motion sensors to sense motion of the device. The various motion sensors 924 may also be implemented as components of an inertial measurement unit in the device.

The device 900 also includes a wireless module 926, which is representative of functionality to perform various wireless communication tasks. For instance, for the sender device 102 and/or the receiver device 104, the wireless module 926 can be leveraged to scan for and detect wireless networks, as well as negotiate wireless connectivity to wireless networks for the sender device 102 and/or the receiver device 104. The device 900 can also include one or more power sources 928, such as when the device is implemented as a mobile device. The power sources 928 may include a charging and/or power system, and can be implemented as a flexible strip battery, a rechargeable battery, a charged super-capacitor, and/or any other type of active or passive power source.

The device 900 also includes an audio and/or video processing system 930 that generates audio data for an audio system 932 and/or generates display data for a display system 934. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 936. In implementations, the audio system and/or the display system are integrated components of the example device. Alternatively, the audio system and/or the display system are external, peripheral components to the example device.

Although implementations of managing data transaction location information have been described in language specific to features and/or methods, the subject of the appended claims is not necessarily limited to the specific features or methods described. Rather, the features and methods are disclosed as example implementations of managing data transaction location information, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a computing device, including: a content control module implemented at least partially in hardware and configured to: receive input data from a remote device that includes a digital image with a request to complete a data transaction; identify a location of the remote device by extracting the location from metadata of the digital image; generate, responsive to completion of the data transaction by the computing device, an association between the location of the remote device and the data transaction; and cause the association between the location and the data transaction to be stored to a storage device.

In some aspects, the techniques described herein relate to a computing device, wherein the input data includes a text message and the digital image depicts a transaction link to initiate the data transaction.

In some aspects, the techniques described herein relate to a computing device, wherein the content control module is further configured to display a map in a user interface of the computing device that depicts the location associated with the data transaction.

In some aspects, the techniques described herein relate to a computing device wherein the content control module is further configured to generate one or more data transaction insights for display in a user interface of the computing device based in part on the association.

In some aspects, the techniques described herein relate to a computing device, wherein the one or more data transaction insights include one or more of a data transaction history, a data transaction resource usage summary, or a data transaction location heatmap.

In some aspects, the techniques described herein relate to a computing device, wherein the one or more data transaction insights are based on a relationship between the association, the location of the remote device, and a location of the computing device during execution of the data transaction.

In some aspects, the techniques described herein relate to a computing device, wherein identification of the location includes extraction of the location from EXIF metadata of the digital image.

In some aspects, the techniques described herein relate to a computing device, wherein identification of the location includes validation of the location against an address of a party to the data transaction.

In some aspects, the techniques described herein relate to a computing device, wherein the association further includes an additional location of the computing device during completion of the data transaction.

In some aspects, the techniques described herein relate to a computing device, including: an image capture device; and a content control module implemented at least partially in hardware and configured to: capture, using the image capture device, a digital image that includes a request to complete a data transaction; associate, responsive to detection that the digital image includes the request to complete the data transaction, a current location of the computing device with the digital image; and communicate the digital image associated with the current location to an additional computing device to complete the data transaction.

In some aspects, the techniques described herein relate to a computing device, wherein the digital image depicts a QR code and the content control module is configured to detect that the digital image includes the request to complete the data transaction by decoding the QR code.

In some aspects, the techniques described herein relate to a computing device, wherein the content control module is configured to identify the current location of the computing device and embed the current location within metadata of the digital image responsive to detection of the request.

In some aspects, the techniques described herein relate to a computing device, wherein the content control module is further configured to receive an indication that the data transaction has been completed by the additional computing device; and generate a transaction receipt that includes an association between the current location and the data transaction.

In some aspects, the techniques described herein relate to a computing device, wherein the content control module is configured to validate the current location of the computing device against an address associated with a party to the data transaction.

In some aspects, the techniques described herein relate to a method, including: receiving, by a user device, input data from a remote client device; detecting a request to initiate a data transaction within the input data; determining, responsive to detection of the request, a location of the remote client device by extracting the location from the input data; generating, responsive to execution of the data transaction by the user device, an association between the location of the remote client device and the data transaction; and causing the association between the location and the data transaction to be stored to a storage device.

In some aspects, the techniques described herein relate to a method, wherein the input data includes a digital image of a QR code and the detecting the request includes decoding the QR code.

In some aspects, the techniques described herein relate to a method, wherein the input data includes a text message and detecting the request includes detecting one or more key words or phrases from the text message that indicate the request to initiate the data transaction.

In some aspects, the techniques described herein relate to a method, further including: accessing the storage device to obtain a plurality of associations between locations and data transactions; and displaying, in a user interface of the user device, a view of a map that includes the plurality of associations between the locations and the data transactions.

In some aspects, the techniques described herein relate to a method, further including: generating, by the user device, one or more data insights based on the plurality of associations; and displaying, in the user interface, the one or more data insights.

In some aspects, the techniques described herein relate to a method, further including generating one or more data transaction insights for display in a user interface of the user device based in part on the association, the location of the remote client device, and a location of the user device during execution of the data transaction.

1. A computing device, comprising:
a content control module implemented at least partially in hardware and configured to:
receive input data that includes a digital image with a request to complete a data transaction between the computing device and a service provider from a non-transacting remote device that does not participate in the data transaction;
identify a location of the non-transacting remote device by extracting the location from metadata of the digital image;
generate, responsive to completion of the data transaction by the computing device with the service provider, an association between the location of the non-transacting remote device and the data transaction that indicates that a transaction location of the data transaction is the location of the non-transacting remote device; and
cause the association between the location and the data transaction to be stored to a storage device.

2. The computing device as described in claim 1, wherein the input data includes a text message and the digital image depicts a transaction link to initiate the data transaction.

3. The computing device as described in claim 1, wherein the content control module is further configured to display a map in a user interface of the computing device that depicts the transaction location as the location of the non-transacting remote device.

4. The computing device as described in claim 1, wherein the content control module is further configured to generate one or more data transaction insights for display in a user interface of the computing device based in part on the association.

5. The computing device as described in claim 4, wherein the one or more data transaction insights include one or more of a data transaction resource usage summary or a data transaction location heatmap.

6. (canceled)

7. The computing device as described in claim 1, wherein identification of the location includes extraction of the location from exchangeable image file format (“EXIF”) metadata of the digital image.

8. The computing device as described in claim 1, wherein identification of the location includes validation of the location against an address of a party to the data transaction.

9. The computing device as described in claim 1, wherein the association differentiates between the transaction location and an additional location of the computing device during completion of the data transaction.

10. A computing device, comprising:
an image capture device; and
a content control module implemented at least partially in hardware and configured to:
capture, using the image capture device, a digital image that includes a request to complete a data transaction with a service provider;
detect that the computing device is unable to participate in the data transaction with the service provider;
associate, responsive to detection that the digital image includes the request to complete the data transaction and that the computing device is unable to participate in the data transaction, a current location of the computing device with the digital image; and
communicate the digital image associated with the current location to an additional computing device that is able to participate in the data transaction.

11. The computing device as described in claim 10, wherein the digital image depicts a quick response (“QR”) code and the content control module is configured to detect that the digital image includes the request to complete the data transaction by decoding the QR code.

12. The computing device as described in claim 10, wherein the content control module is configured to identify the current location of the computing device and embed the current location within metadata of the digital image responsive to detection of the request.

13. The computing device as described in claim 10, wherein the content control module is further configured to receive an indication that the data transaction has been completed by the additional computing device; and
generate a transaction receipt that includes an association between the current location and the data transaction.

14. The computing device as described in claim 10, wherein the content control module is configured to validate the current location of the computing device against an address associated with a party to the data transaction.

15. A method, comprising:
receiving, by a user device, input data from a remote client device;
detecting a request within the input data to initiate a data transaction with a service provider that the remote client device is unable to participate in;
determining, responsive to detection of the request, a location of the remote client device by extracting the location from the input data;
generating, responsive to execution of the data transaction by the user device, an association between the location of the remote client device and the data transaction; and
causing the association between the location and the data transaction to be stored to a storage device.

16. The method as described in claim 15, wherein the input data includes a digital image of a quick response (QR) code and the detecting the request includes decoding the QR code.

17. The method as described in claim 15, wherein the input data includes a text message and detecting the request includes detecting one or more key words or phrases from the text message that indicate the request to initiate the data transaction.

18. The method as described in claim 17, further comprising:
accessing the storage device to obtain a plurality of associations between locations and data transactions; and
displaying, in a user interface of the user device, a view of a map that includes the plurality of associations between the locations and the data transactions.

19. The method as described in claim 18, further comprising:
generating, by the user device, one or more data transaction insights based on the plurality of associations; and
displaying, in the user interface, the one or more data transaction insights.

20. The method as described in claim 19, wherein the one or more data transaction insights are generated based in part on the association, the location of the remote client device, and a location of the user device during execution of the data transaction.

21. The computing device as described in claim 1, wherein the content control module is further configured to generate a data transaction insight for presentation by the computing device based on the association that visually represents a relationship between the location of the non-transacting remote device and a location of the computing device during execution of the data transaction.
